(19) United States
(12) Patent Application Publication
(10) Pub. No.: US 2009/0211776 A1
(43) Pub. Date: Aug. 27, 2009

(54) PLASMA DISPLAY PANEL

(76) Inventors: Akira Shimoyoshi, Miyazaki (JP); Masashi Nishiki, Miyazaki (JP); Tetsuyoshi Tomioka, Miyazaki (JP)

Correspondence Address: MILES & STOCKBRIDGE PC, 1751 PINNACLE DRIVE, SUITE 500, MCLEAN, VA, 22102-3833, US

(21) Appl. No.: 12/295,346

(22) PCT Filed: Apr. 7, 2006
(86) PCT No.: PCT/JP2006/307479

§ 371 Date: Mar. 26, 2009

(51) Int. Cl. H01J 5/00

(52) U.S. Cl. 174/50.61

(57) ABSTRACT

A position adjustment of substrates is facilitated by using a sealing/bonding material consisting of a translucent colored glass material. A plasma display panel has a frontside substrate and a backside substrate facing to each other, on which electrodes are formed respectively, and a sealing/bonding material placed on a sealing/bonding area on a peripheral portion of one of the substrates, by which the two substrates are sealed and bonded to each other. The sealing/bonding material is made from a translucent colored material.

### TECHNICAL FIELD

This present invention relates to a plasma display panel (hereinafter, referred to as a “PDP”), and more specifically relates to an improvement of a sealing/bonding portion of the PDP in which a frontside substrate and a backside substrate are made face to face with each other, with a peripheral portion being sealed and bonded to each other by a sealing/bonding material.

### BACKGROUND ART

A three-electrode surface-discharge-type PDP of an AC-drive type has been known as a conventional PDP. In this PDP, a large number of display electrodes capable of surface-discharging are formed on an inner face of one of glass substrates to be a frontside in a horizontal direction, and a large number of address electrodes for use in selecting light-emitting cells are formed on an inner face of the other glass substrate to be a backside in a direction intersecting with the display electrodes so that each of intersections between the display electrodes and the address electrodes is designed to form one cell (unit light-emitting area). Stripe-shaped or lattice-shaped barrier ribs, which divide a discharge space, are formed at positions between adjacent address electrodes on the backside substrate as well as at positions corresponding to gaps between display lines defined by the display electrodes, and each of R-use, G-use and B-use phosphor layers is formed between barrier ribs separating respective areas corresponding to R cell, G cell and B cell. One pixel is configured by three cells, that is, a red (R) cell, a green (G) cell and a blue (B) cell.

A PDP is manufactured through processes in which one of glass substrates and the other glass substrate, thus formed, are aligned face to face with each other, and peripheral portions thereof are sealed and bonded to each other so as to be tightly sealed by a low-melting-point glass sealing/bonding material (referred to also as a sealing material), with a discharge gas being enclosed inside thereof (see Japanese Patent No. 3,237,544 (corresponding to U.S. Pat. No. 5,985,069) and Japanese Patent No. 3,428,446 (corresponding to U.S. Pat. No. 6,600,265)).

### DISCLOSURE OF THE INVENTION

### Problems to be Solved by the Invention

In the PDP, the frontside substrate and the backside substrate on which constituent elements, such as electrodes and the barrier ribs, have been preliminarily formed separately, are assembled to manufacture a panel; therefore, upon sealing/bonding the two substrates, positioning processes between the substrates are important. Moreover, with respect to a sealing/bonding material to be formed on a periphery of the backside substrate prior to sealing/bonding processes, it is important to appropriately set its coating position. For this reason, alignment marks (matching marks) for use in assembling are respectively formed on areas outside the display areas of the two substrates to be assembled, simultaneously with the formation of the electrodes by using the same material, or a reference mark indicating an appropriate sealing/bonding material coating position is preliminarily formed on the backside substrate, and normally, by utilizing these marks, the positioning processes of the substrates and determining and inspecting processes of the coating position of the sealing/bonding material relative to the backside substrate are carried out.

Here, in the PDP mainly composed of two glass substrates as described above, together with developments of high-precision and large-size devices, there have been strong demands for increasing a space efficiency of the substrate surface from a viewpoint of achieving light-weight devices, and the space to be used for forming the alignment marks and the like other than required functions for displaying is desirably made as small as possible. Accordingly, when the number and layout positions of the alignment marks are limited from such viewpoints, a recognizing precision of the alignment marks tends to be lowered, and confirming inspection processes for the sealing/bonding material coating position might become difficult.

In view of such a circumstance, it is an object of the present invention to impart a function other than a sealing function to a sealing/bonding area on the periphery of substrates where the sealing/bonding material is provided. Moreover, it is another object of the present invention to improve the space efficiency of a substrate surface by utilizing the sealing/bonding area for multiple purposes. More specifically, in the present invention, since the sealing/bonding material is allowed to have a translucent colored property, the alignment marks and the reference marks can be provided at positions to be overlapped with the sealing/bonding material as well as positions adjacent thereto so that, with this arrangement, an assembling precision of the substrates can be improved and the confirming inspection processes can be made easier.

### Means to Solve the Problems

In short, in order to achieve the objects, the present invention provides A plasma display panel comprising: a frontside substrate and a backside substrate facing each other, on which electrodes are formed respectively; and a sealing/bonding material placed on a sealing/bonding area on a peripheral portion of one of the substrates, by which the two substrates are sealed and bonded to each other; characterized in that the sealing/bonding material is made from a translucent colored material.

### EFFECTS OF THE INVENTION

In accordance with the present invention, since the sealing/bonding material is colored so as to have the translucent colored property, other functions such as an identifying function can be imparted to the sealing/bonding area itself. In particular, in the case when the alignment marks used for matching and the reference marks indicating the coating position of the sealing/bonding material are formed right beneath the sealing/bonding material, the space used for forming the alignment marks, conventionally required and placed outside or inside the sealing/bonding area (sealing portion), can be omitted so that the space efficiency of the substrate surface can be subsequently improved. Moreover, within a sealing/bonding area surrounding four sides of the substrate, the number of the marks may be increased, and by coloring the sealing/bonding material, identification from colors of marks (electrodes) can be easily made so that the assembling precision of the substrates can be improved, and the confirming inspection processes can be easily carried out.

### BRIEF DESCRIPTION OF THE DRAWINGS

FIGS. 1(a) and 1(b) are explanatory drawings which show a structure of a PDP in accordance with the present invention.

FIGS. 2(a) and 2(b) are explanatory drawings which show alignment marks formed on a frontside substrate and a backside substrate of the present invention.

FIGS. 3(a) and 3(b) are explanatory drawings which show the alignment marks in detail in the present invention.

FIG. 4 is an explanatory drawing which shows the alignment marks used upon positioning the substrates in the present invention.

### REFERENCE NUMERALS

10 PDP
11 Frontside substrate
17, 24 Dielectric layer
18 Protective film
21 Backside substrate
28R, 28G, 28B Phosphor layer
29 Barrier rib
30 Discharge space
31 Sealing/bonding material area
32 Backside alignment mark
33 Frontside alignment mark
34 Sealing/bonding material coating position reference mark
A Address electrode
L Display line
X, Y Display electrode

### BEST MODE FOR CARRYING OUT THE INVENTION

In the present invention, examples of a backside substrate and a frontside substrate include a substrate made of glass, quartz or ceramics and a substrate prepared by forming desired constituent elements, such as an electrode, an insulating film, a dielectric film and a protective layer, on such substrates.

Electrodes may be formed on the backside substrate. These electrodes may be formed by using various materials and methods conventionally known in the art. Examples of materials used for these electrodes include transparent conductive materials, such as ITO and SnO₂, and metal conductive materials, such as Ag, Au, Al, Cu and Cr. Various methods conventionally known in the art can be used for forming the electrodes. For example, a thick-film-forming technique such as printing may be used for forming the electrodes, or a thin-film-forming technique, such as a physical deposition method and a chemical deposition method, may be used for forming them. Examples of the thick-film-forming technique include such as a screen printing method. Examples of the physical deposition method in the thin-film-forming technique include such as a vapor deposition method or a sputtering method. Examples of the chemical deposition method include such as a thermal CVD method, an optical CVD method, or a plasma CVD method. More specifically, a metal electrode having a three-layer structure of Cr/Cu/Cr and a metal electrode made of aluminum may be used as the electrode. Moreover, a paste fired film, formed by applying a paste of Ag or Au thereto and firing it thereon, may be used.

An alignment mark having a color different from that of a sealing/bonding material may be formed on at least one of the backside substrate and the frontside substrate in a manner so as to be adjacent to a sealing/bonding area, or so as to be overlapped with the corresponding area.

The sealing/bonding material may be placed on the sealing/bonding area on the periphery of the backside substrate. The sealing/bonding material is preferably formed by using a ZnO.Bi₂O₃.B₂O₃-based low-melting-point leadless glass material.

In addition to this, the sealing/bonding material may be formed by using a PbO.B₂O₃-based low-melting-point lead glass material. Alternatively, a thermosetting or a UV curable resin sealing/bonding material may be used. In order to impart a translucent colored property to the sealing/bonding material, an appropriate colorant may be added thereto. For example, in the case of a sealing/bonding material of low-melting-point glass, by adding thereto metal such as copper, cobalt, chromium and iron, or a metal oxide thereof, as a pigment color (coloring pigment), a glass sealing/bonding material may be colored. For example, the sealing/bonding material may be colored into a green-based color.

A dielectric layer and barrier ribs may be formed on the backside substrate. In this case, the dielectric layer and the barrier ribs are preferably formed by using a leadless glass material. With respect to the dielectric layer used for coating display electrodes on the frontside substrate also, a dielectric layer of silicon dioxide, formed by leadless low-melting-point glass or a thin-film process, may be used so that an entire PDP may be formed into a lead-free structure.

Referring to Figures, the present invention will be described in detail by means of embodiments, hereinafter. Here, the present invention is not intended to be limited by these, and various modifications may be made therein.

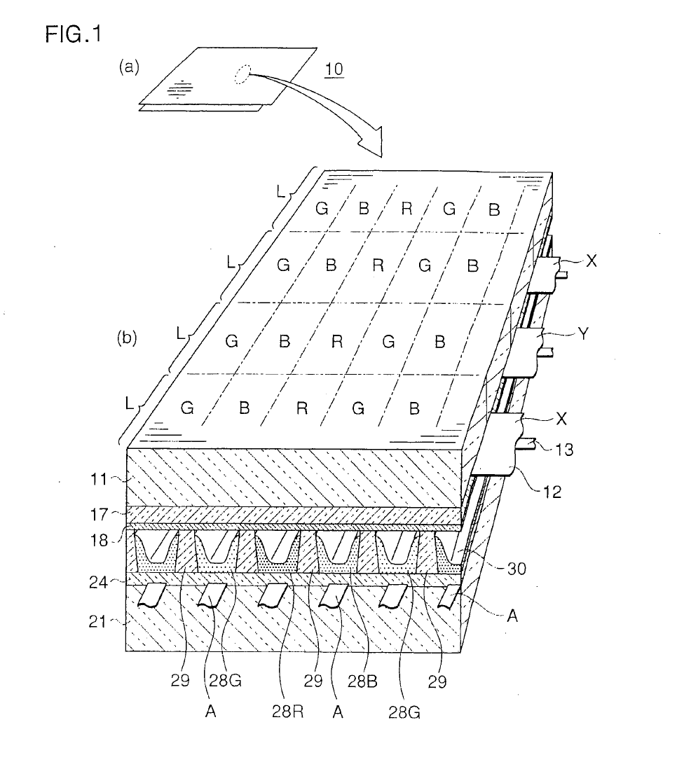

FIGS. 1(a) and 1(b) are explanatory drawings which show a structure of a PDP of the present invention. FIG. 1(a) is a general view, and FIG. 1(b) is a partially exploded perspective view. This PDP is a three-electrode surface-discharge-type PDP of an AC-drive type for color display.

A PDP 10 is configured by a frontside substrate 11 on which constituent elements having functions as the PDP are formed, and a backside substrate 21. As the frontside substrate 11 and the backside substrate 21, for example, glass substrates are used; however, in addition to the glass substrate, a quartz substrate, a ceramic substrate or the like may be used.

On the inner side face of the frontside substrate 11, display electrodes X and display electrodes Y are disposed with equal intervals in a horizontal direction. All gaps between adjacent display electrodes X and the display electrodes Y form display lines L. Each of the display electrodes X and Y is configured by a transparent electrode 12 having a wide width, made of ITO, SnO₂ or the like, and a bas electrode 13 having a narrow width, made of, for example, Ag, Au, Al, Cu, and Cr, as well as a laminated body (for example, Cr/Cu/Cr laminated structure) thereof or the like. Upon forming these display electrodes X and Y, the thick-film-forming technique such as the screen-printing process is used for Ag and Au, and the thin-film-forming technique, such as the vapor deposition method and the sputtering method, and an etching technique are used for the other materials so that a desired number of electrodes having a desired thickness, width and gap can be formed.

Here, in the present PDP, a PDP having a so-called ALIS structure in which the display electrodes X and the display electrodes Y are placed with equal intervals, with each gap between the adjacent display electrode X and the display electrode Y being allowed to form the display line L, has been exemplified; however, the present invention may also be applied to a PDP having a structure in which paired display electrodes X and Y are placed separately with a distance (non-discharge gap) in which no discharge is generated.

On the display electrodes X and Y, a dielectric layer 17 is formed in a manner so as to cover the display electrodes X and Y. The dielectric layer 17 is formed by processes in which a glass paste, made from a leadless glass flit, a binder resin and a solvent, is applied onto the frontside substrate 11 by using the screen-printing method and fired thereon.

A protective film 18, used for protecting the dielectric film 17 from damage due to collision of ions generated by discharge upon displaying, is formed on the dielectric layer 17. This protective film is made from MgO. The protective film may be formed by using the known thin-film forming process in the art, such as an electron beam vapor deposition method and the sputtering method.

On the inner side face of the backside substrate 21, a plurality of address electrodes A are formed in a direction intersecting with the display electrodes X and Y on the plan view, and a dielectric layer 24 is formed in a manner so as to cover the address electrodes A. The address electrodes A, which generate an address discharge used for selecting cells to emit light at intersections with the display electrodes Y, is formed into a three-layer structure of Cr/Cu/Cr. These address electrodes A may also be formed by using another material, such as Ag, Au, Al, Cu and Cr. In the same manner as in the display electrodes X and Y, upon forming these address electrodes A, the thick-film-forming technique such as the screen-printing process is used for Ag and Au, and the thin-film-forming technique, such as the vapor deposition method and the sputtering method, and the etching technique are used for the other materials so that a desired number of electrodes having desired thickness, width and gap can be formed. The dielectric layer 24 is formed on the address electrodes A so as to cover the address electrodes A. The dielectric layer 24 is formed by processes in which the glass paste, made from the leadless glass flit, the binder resin and the solvent, is applied onto the backside substrate 21 by using the screen-printing method and fired thereon.

A plurality of barrier ribs 29 having a stripe shape are formed on the dielectric layer 24 between the adjacent address electrodes A. Not limited to this shape, the shape of the barrier ribs 29 may have a mesh shape (box shape) to divide a discharge space for each of the cells. The barrier ribs 29 are formed through a method, such as a sand blasting method, a printing method and a photoetching method. For example, in the sand blasting method, a glass paste, made from a low-melting-point glass frit, a binder resin, a solvent and the like, is applied onto a dielectric layer 24, and after the glass paste has been dried, cut particles are blasted onto the resulting glass paste layer, with a cutting mask having apertures of a barrier rib pattern being provided thereon, so that the glass paste layer exposed to the mask apertures is cut, and the resulting glass paste layer is then fired; thus, the barrier ribs are formed. Moreover, in the photoetching method, in place of cutting by using the cut particles, a photosensitive resin is used as the binder resin, and after exposing and developing processes by the use of a mask, the resulting glass paste layer is fired so that the barrier ribs are formed.

On side faces and a bottom face of a concave-groove-shaped discharge space between the barrier ribs 29, phosphor layers 28R, 28G and 28B corresponding to red (R), green (G) and blue (B) are formed. The phosphor layers 28R, 28G and 28B are formed through processes in which a phosphor paste containing a phosphor powder, a binder resin and a solvent is applied onto inside of the discharge space having a concave groove shape between the barrier ribs 29 by using the screen-printing method or a method using a dispenser, and after these processes have been repeated for each of the colors, a firing process is carried out thereon. These phosphor layers 28R, 28G and 28B may also be formed by using a photolithographic technique in which a sheet-shaped phosphor layer material (so-called green sheet) containing the phosphor powder, the photosensitive material and the binder resin is used. In this case, a sheet having a desired color may be affixed onto an entire face of a display area on the substrate, and the sheet is subjected to exposing and developing processes; thus, by repeating these processes for each of the colors, the phosphor layers having the respective colors are formed in the corresponding gaps between the barrier ribs.

The dielectric layer 24 and the barrier ribs 29 to be formed on the backside substrate 21 are made from a leadless glass material having a composition shown below:

ZnO: 30 to 40% by weight

B₂O₃: 20 to 30% by weight

SiO₂: 10 to 30% by weight

Others (modifier oxides): 0 to 20% by weight

The PDP is manufactured through processes in which the frontside substrate 11 having these constituent elements formed thereon and the backside substrate 21 are aligned face to face with each other in a manner so as to allow the display electrodes X, Y and address electrodes A to intersect with each other, and the peripheral portion thereof is sealed with the sealing/bonding material, with a discharge space 30 surrounded by the barrier ribs 29 being filled with a discharge gas formed by mixing such as Xe and Ne. In this PDP, the discharge space 30 at each of intersections between the display electrodes X, Y and the address electrodes A forms one cell (unit light-emitting area) which is a minimum unit of display. One pixel is configured by three cells of R, B and G.

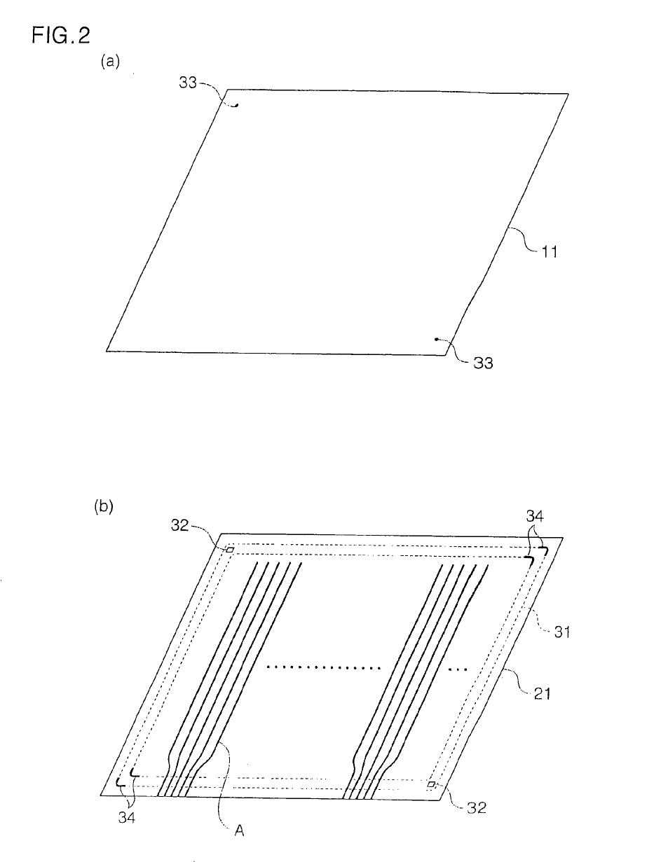

FIGS. 2(a) and 2(b) are explanatory drawings which show alignment marks formed on the frontside substrate and the backside substrate. FIG. 2(a) shows the frontside substrate and FIG. 2(b) shows the backside substrate.

On the backside substrate 21, a sealing/bonding area 31, hypothetically indicated by broken lines so as to place the sealing/bonding material on the periphery of the substrate, is disposed. Moreover, on the backside substrate 21, backside alignment marks 32 are respectively placed at two corner portions which form diagonal angles facing each other. These backside alignment marks 32 are formed at positions which are superposed on the sealing/bonding area 31 when seen on the plan view. Here, in order to determine an appropriate applying position upon applying the low-melting-point glass paste to form the sealing/bonding material onto the sealing/bonding area 31 by using, for example, a dispenser system, reference marks 34 are provided at portions of inner and outer edges of a hypothetical sealing/bonding area indicated by the broken lines, that is, for example, at corner portions which form diagonal angles opposing to positions of the alignment marks 32.

The backside alignment marks 32 and the reference marks 34 for a coating position are formed upon forming the address electrodes A on the backside substrate 21, simultaneously with the formation of the address electrodes A, by using the same material (three-layer structure of Cr/Cu/Cr). These are formed in the following processes.

After forming a metal film having the three-layer structure of Cr/Cu/Cr on the entire substrate, a photosensitive dry film is laminated thereon or a resist is applied thereto, and by exposing this through a photomask and developing this, the address electrodes A are formed by etching the metal film.

Alternatively, in the case when Ag is used, a photosensitive Ag paste is applied onto the entire substrate, or applied with a thickness thicker than that of an electrode to be formed by using the screen printing method, and after having been dried, the photosensitive Ag paste is exposed, developed and fired so that the address electrodes A are formed.

Therefore, by using a pattern with the alignment marks as the photomask upon exposing the dry film or the resist, or upon exposing the photosensitive Ag paste, the backside alignment marks 32 or the reference mark 34 are formed simultaneously with the address electrodes A. A positional relationship between the address electrodes A and the backside alignment marks 32 or the reference mark 34 is set in a predetermined positional relationship in a designing stage so as not to cause problems mutually.

On the frontside substrate 11, frontside alignment marks 33 are also formed at two portions corresponding to the positions of the backside alignment marks. These frontside alignment marks 33 are formed simultaneously as a bus electrode is formed on the frontside substrate 11 by using the same material (three-layer structure of Cr/Cu/Cr). These are formed in the following manner.

After forming the metal film having the three-layer structure of Cr/Cu/Cr on the entire substrate, the photosensitive dry film is laminated thereon or the resist is applied thereto so that, after exposing this through a photomask and developing this, the bus electrode is formed by etching the metal film.

Therefore, by using the pattern with the alignment marks as the photomask upon exposing the dry film or the resist, the frontside alignment mark 33 is formed simultaneously with the bus electrode. The positional relationship between the bus electrode and the frontside alignment mark 33 is set in a predetermined positional relationship in the designing stage.

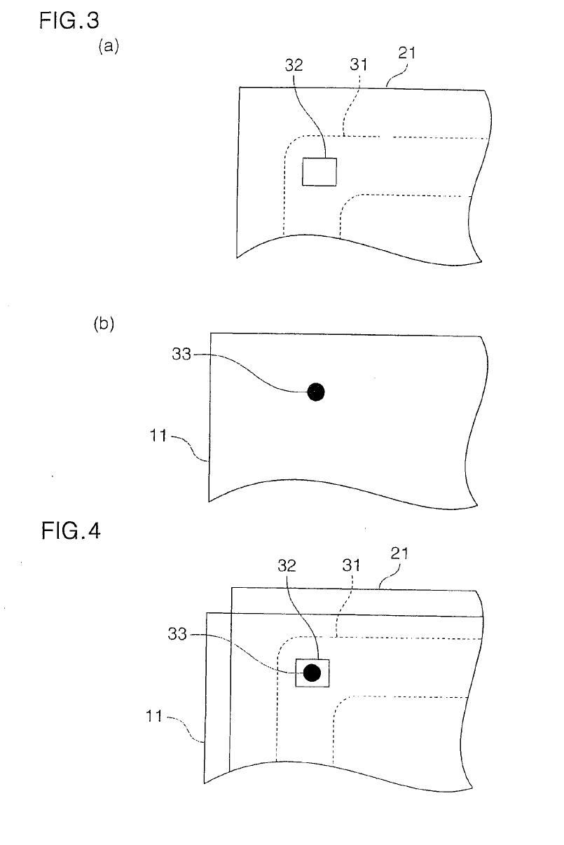

FIGS. 3(a) and 3(b) are explanatory drawings which show the alignment marks in detail. FIG. 3(a) shows the frontside alignment mark, and FIG. 3(b) shows the backside alignment mark. The backside alignment mark 32 forms a shape of a rectangular frame. The frontside alignment mark 33 forms a black round shape.

FIG. 4 is an explanatory drawing which shows the alignment marks used upon positioning the substrates. As shown in this Figure, upon positioning the backside substrate 21 and the frontside substrate 11, a positioning process is carried out so that the frontside alignment mark 33 is superposed on the center of the backside alignment marks 32.

By carrying out the positioning process of the backside substrate 21 and the frontside substrate 11 by using the backside alignment marks 32 and the frontside alignment mark 33, it is possible to accurately determine the positional relationship between the address electrode and the bus electrode.

As shown in FIG. 2(b), upon sealing/bonding the backside substrate 21 and the frontside substrate 11, the sealing/bonding material is preliminarily disposed on the sealing/bonding area 31 of the backside substrate 21. The backside substrate 21 and the frontside substrate 11 are bonded to each other by this sealing/bonding material so that an air-tight property between the two substrates is ensured. In the preliminary disposition of the sealing/bonding material, the low-melting-point glass paste used as the sealing/bonding material is applied onto the sealing/bonding area, following a predetermined track based upon the reference mark 34, for example, by the use of an automatic machine of a dispenser type.

This sealing/bonding material is made from a translucent colored glass material. The sealing/bonding material has a base glass composition mainly made from the following components.

Pb: 75 to 85% by weight

B₂O₃: 0 to 10% by weight

SiO₂: 0 to 10% by weight

Others (modifier oxides): 0 to 10% by weight

The material is a lead-containing glass material. In order to impart the translucent colored property to the sealing/bonding material, an appropriate colorant is added to the glass material. For example, by adding to the glass material metal such as copper, cobalt, chromium and iron, or a metal oxide thereof, as a pigment color (coloring pigment), the sealing/bonding material is colored into a green-based color tone, other than a black-based, gray-based or white-based color tone. An added amount of an additive, such as copper, cobalt, chromium and iron, is set to 3% by weight or less, that is, to such an appropriate amount as not to impair fluidity and air-tight property of the sealing/bonding material.

In order to allow the sealing/bonding material to have the translucent colored property, the leadless glass material may be used. In this case, as the sealing/bonding material, those materials are preferably used in which the base glass composition is mainly set as follows. In the case of the leadless glass material, by using bismuth oxide (Bi₂O₃) as its main component, a glass softening point can be lowered so that a low-melting-point leadless glass may be formed.

ZnO: 0 to 10% by weight

B₂O₃: 0 to 10% by weight

Bi₂O₃: 65 to 86% by weight

SiO₂: 0 to 10% by weight

Others (modifier oxides): 0 to 15% by weight

In the case when the ZnO.Bi₂O₃.B₂O₃-based low-melting-point leadless glass material is used as the sealing/bonding material, it becomes possible to impart the translucent colored property to the sealing/bonding material, without the necessity of using the colorant. That is, the ZnO.Bi₂O₃.B₂O₃-based low-melting-point leadless glass exhibits a semi-transparent yellowish green color in its fused state. Therefore, the alignment mark formed on the surface of the backside glass substrate can be identified from above the frontside glass substrate through the sealing/bonding material.

In this manner, by using the leadless glass material, it is possible to simultaneously satisfy both of the colored sealing/bonding material and a reduction (leadless) of load to an environment. Although the leadless glass material is colored, another colorant may be further added to this colored glass material.

As described above, by forming the sealing/bonding material by using a colored transparent material, various identifying functions can be added to the sealing/bonding area. With this arrangement, backside substrate alignment marks, which have been conventionally formed on areas other than the sealing/bonding areas because the conventional sealing/bonding material is formed as a black or white sealing/bonding material, can be formed inside the sealing/bonding area so that the space efficiency of the substrate face is improved. Moreover, it becomes possible to easily inspect for a positional deviation from the reference mark 34 which has been preliminarily formed on the backside substrate face on which the sealing/bonding material is to be formed, so as to indicate the coating position.

Moreover, by adding the pigment to the lead-containing glass material or the leadless glass material on demand so as to adjust a color of the sealing/bonding material, a PDP product with a colored edge portion is obtained so that an appearance can be improved from a designing point of view. In particular, the sealing/bonding material using leadless glass exhibits a yellowish green color, and by emphasizing the yellowish green color into a green-based color, an identifying effect of the material for its environmental applicability can be obtained. That is, in the conventional PDP, the dielectric layer used for coating the display electrodes on the frontside substrate, the dielectric layer used for coating the address electrodes on the backside substrate, the barrier ribs used for dividing the discharge space and the sealing/bonding material used for sealing gaps between the substrates are generally formed respectively by using a lead oxide (PbO) based low-melting-point glass; however, in the case when all of these members are made from the zinc borosilicate based and/or the zinc bismuth borosilicate based leadless low-melting-point glass, by coloring the glass to form the sealing/bonding material into the green-based color, the resulting product is allowed to have an identifying function as an ecology conscious product. In this case, a reason that the bismuth-based low-melting-point glass which has been exemplified earlier is used as the sealing/bonding material is because, since its thermal process needs to be carried out later than the formation of the dielectric layer, the corresponding process can be carried out at a lower temperature level than that of the zinc-based low-melting-point glass of the dielectric layer.

### Example 1

By omitting colorants from gray and black colored sealing/bonding glass materials, electrode materials were made to be easily observed. By omitting coloring fillers, the sealing/bonding material became transparent when a lead-based material is used as the sealing/bonding material, while the sealing/bonding material came to exhibit a semi-transparent yellowish green color when a bismuth-based material is used as the sealing/bonding material.

Since the sealing/bonding material became transparent or semi-transparent, the alignment marks, formed by Cr/Cu/Cr electrodes having the same type of color as the sealing/bonding material, could be easily confirmed, and even in the case when the alignment mark and the reference mark were disposed below the sealing/bonding material, the positioning process between the frontside substrate and the backside substrate could be carried out with high precision, and an inspecting process for confirming whether or not the sealing/bonding material had been applied to an appropriate position could be carried out easily.

### Example 2

By adding copper oxide (CuO), a chromium compound (Cr₂O₃), nickel oxide (NiO), etc. to the lead-containing glass material or the leadless glass material in a range of 3% by weight or less as the colorant, the sealing/bonding material was colored into the green-based color.

By coloring the sealing/bonding material into a color different from that of the electrode material, an image recognizing precision was improved upon carrying out the positioning process of the alignment marks through image recognition, and an inspecting sensitivity on the coating position precision of the sealing/bonding material could be greatly improved.

Moreover, in the case when a sealing/bonding portion itself, colored into the green-based color, was used as the alignment mark to be used upon combining a panel and modules, the image recognizing precision was improved in the same manner as in the coating position inspection for the sealing/bonding material, and a combining precision of the substrate was subsequently improved.

Furthermore, by coloring the sealing/bonding material into a blue-based color through an addition of cobalt oxide (CoO) or copper oxide (CuO), or by coloring it into a yellow-based color through an addition of cerium oxide (CeO₂) and titanium oxide (TiO₂), the same effects could be obtained.

### Example 3

A black pigment was omitted from the lead-containing glass material or the leadless glass material, and to this was added the chromium compound (Cr₂O₃) in a range of 1% by weight or less so that the resulting sealing/bonding material was colored into a faint green color.

Since it became possible to easily confirm the reference marks formed by the Cr/Cu/Cr electrodes even by visual observation, the recognizing precision of an image recognition device could be improved so that it became possible to apply the sealing/bonding material to a predetermined sealing/bonding area on the backside substrate, by using the dispenser-type automatic coating device. As a result, positional deviations due to assembling process could be eliminated.

### Example 4

In the case when electrodes were made of Ag, since the electrodes looked white or yellowish, the added amount of the colorant was increased so that the sealing/bonding material was colored into a dark blue, or a dark green-based color; thus, the same effects were obtained.

As described above, in accordance with the present invention, by allowing the sealing/bonding material to be used upon sealing/bonding the frontside substrate and the backside substrate to each other to have the translucent colored property, the sealing/bonding area is allowed to exert functions other than the sealing function. In particular, since the alignment marks and the reference marks can be provided even at positions where they are overlapped with the sealing/bonding material, the space efficiency of the substrate face can be improved, and since the alignment marks and the reference marks can be easily recognized through the sealing/bonding material, it becomes possible to improve the coating position precision of the sealing/bonding material and a matching precision upon assembling the substrates. Moreover, since limitations to a layout position of the alignment mark are eliminated, a degree of freedom upon designing an electrode pattern can be improved.

1. A plasma display panel comprising:
a frontside substrate and a backside substrate facing each other, on which electrodes are formed respectively; and
a sealing/bonding material placed on a sealing/bonding area on a peripheral portion of one of the substrates, by which the two substrates are sealed and bonded to each other;
characterized in that the sealing/bonding material is made from a translucent colored material.

2. The plasma display panel according to claim 1, wherein an alignment mark having a color different from that of the sealing/bonding material is provided on at least one of the frontside substrate and the backside substrate in a manner so as to be adjacent to the sealing/bonding area or overlapped with the sealing/bonding area.

3. The plasma display panel according to claim 1, wherein the sealing/bonding material is made of a ZnO.Bi₂O₃.B₂O₃-based low-melting-point leadless glass material.

4. The plasma display panel according to claim 1, wherein the sealing/bonding material is colored into a green-based color.

5. The plasma display panel according to claim 4, further comprising:
an array of display electrodes, covered with a leadless dielectric layer, which are placed on the frontside substrate; and
electrodes, a dielectric layer covering the electrodes, and barrier ribs dividing an opposing space between the two substrates, which are placed on the backside substrate,
wherein these dielectric layers and barrier ribs are made of a leadless glass material.

6. The plasma display panel according to claim 2, wherein the sealing/bonding material is colored into a green-based color.

7. The plasma display panel according to claim 6, further comprising:
an array of display electrodes, covered with a leadless dielectric layer, which are placed on the frontside substrate; and
electrodes, a dielectric layer covering the electrodes, and barrier ribs dividing an opposing space between the two substrates, which are placed on the backside substrate,
wherein these dielectric layers and barrier ribs are made of a leadless glass material.

8. The plasma display panel according to claim 2, wherein the sealing/bonding material is made of a ZnO.Bi₂O₃.B₂O₃-based low-melting-point leadless glass material.

9. The plasma display panel according to claim 8, wherein the sealing/bonding material is colored into a green-based color.

10. The plasma display panel according to claim 9, further comprising:
an array of display electrodes, covered with a leadless dielectric layer, which are placed on the frontside substrate; and
electrodes, a dielectric layer covering the electrodes, and barrier ribs dividing an opposing space between the two substrates, which are placed on the backside substrate,
wherein these dielectric layers and barrier ribs are made of a leadless glass material.

11. The plasma display panel according to claim 3, wherein the sealing/bonding material is colored into a green-based color.

12. The plasma display panel according to claim 11, further comprising:
an array of display electrodes, covered with a leadless dielectric layer, which are placed on the frontside substrate; and
electrodes, a dielectric layer covering the electrodes, and barrier ribs dividing an opposing space between the two substrates, which are placed on the backside substrate,
wherein these dielectric layers and barrier ribs are made of a leadless glass material.
